(19) United States
(12) Patent Application Publication
(10) Pub. No.: US 2004/0230692 A1
(43) Pub. Date: Nov. 18, 2004

(54) Business device, information device, business device information management system, business device information management method, and business device information management program

(75) Inventors: Osamu Tachiyama, Tachikawa-shi (JP); Tsuneo Kohari, Mishima-shi (JP); Jun Sasano, Kokubunji-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/784,887

(22) Filed: Feb. 24, 2004

(30) Foreign Application Priority Data
Feb. 28, 2003 (JP) 2003-053013

(51) Int. Cl. G06F 15/16

(52) U.S. Cl. 709/230; 358/1.15

(57) ABSTRACT

An MFP, e.g. a printer or a scanner, allows a PC on the Internet to easily acquire MIB information from the MFP. An MFP and a PC are connected via the Internet through a firewall. When the MFP accesses the PC by using HTTP to thereby open a firewall, the PC transmits an OID request command to the MFP as tag information in XML. On the basis of the received OID request command, the MFP extracts equipment information (e.g. counter information) corresponding to the tag information from MIB indicating the equipment status of the MFP, prepares OID by describing the equipment information in XML, and transmits the OID to the PC. Thus, the PC can acquire equipment information (e.g. counter information) concerning the MFP on the basis of the received OID.

### BACKGROUND OF THE INVENTION

1. Field of the Invention

The present invention relates to business devices and so forth that can communicate with information devices (personal computers; hereinafter referred to as “PCs”), e.g. servers, connected to a network. More specifically, the present invention relates to a business device capable of communicating information indicating its own device status to a PC (information device). The present invention also relates to the information device and an information management system for the business device. Further, the present invention relates to an information management method for the business device and an information management program that instructs a computer to execute information management for the business device.

2. Description of the Related Art

Conventionally, a business device such as a printer, a scanner or a FAX [hereinafter referred to as “MFP” (Multi-Functional Peripheral)] transmits information indicating its own device status [hereinafter referred to as “MIB” (Management Information Base)] to a PC in an intranet. At this time, the MFP and the PC in the intranet communicate the MFP's MIB information by using an SNMP (Simple Network Management Protocol) as a network management protocol. For example, in response to a request from a PC in the intranet, the MFP transmits individual equipment information such as counter information, address information, recording paper information, or error information [hereinafter referred to as “OID” (Order Information Data)] as its own MIB information to the PC by protocol communication using SNMP.

However, with the diversification of the mode of using MFPs, there have been demands for the range of communication to be extended to PCs outside an intranet. That is, there have been demands for capability of accessing an MFP from a PC on the Internet to acquire MIB information concerning the relevant MFP. Incidentally, in order to allow an MFP to be accessed from a PC on the Internet, a firewall needs to be provided at the entrance to the MFP to prevent unauthorized access. However, such a firewall has no communication port for SNMP. Therefore, MFPs that are arranged to communicate with PCs within an intranet as in the past cannot communicate with PCs on the Internet. Further, conventional communication systems use HTML (Hyper Text Markup Language) as a means for exchanging OID between an MFP and a PC. Therefore, the HTML format and OID cannot be defined separately from each other. This gives rise to some problems. For example, the document structure becomes complicated.

It should be noted that Japanese Patent Application Unexamined Publication (KOKAI) No. 2000-353140 (paragraph Nos. 0072 to 0099, and FIGS. 5 and 6) discloses a technique for acquiring MIB via HTML from a device on a network by using SNMP and HTTP as communication protocol. With this technique, even when the MIB information concerning a particular device has been changed, only the newly set MIB information can be acquired. Therefore, it is possible to prevent an increase in traffic on the network and also possible to prevent an increase in load on the device. However, because it uses HTML as a means for exchanging data, the technique disclosed in the above-mentioned publication involves problems similar to those experienced with the first-described conventional technique. That is, the document structure becomes complicated, and usability at the user side is degraded.

### SUMMARY OF THE INVENTION

The present invention was made in view of the above-described problems with the prior art.

Accordingly, an object of the present invention is to provide a business device, an information device, a business device information management system, a business device information management method, and a business device information management program that are arranged so that a PC on the Internet can easily acquire MIB information concerning a business device, e.g. a printer, a scanner, or a FAX, from the business device.

To attain the above-described object, the present invention provides a business device capable of transmitting and receiving OID (Order Information Data) indicating individual equipment status in MIB information indicating the device status of the business device through the Internet to and from an information device connected to the Internet. When the OID is transmitted and received between the business device and the information device, a communication protocol that can be handled on the Internet is used, and the OID is described as tag information in a language compatible with the communication protocol.

In addition, the present invention provides a business device capable of transmitting and receiving OID indicating individual equipment status in MIB information indicating the device status of the business device to and from a first information device connected to the Internet and a second information device connected to an intranet. The business device includes an MIB information storage section that stores MIB information indicating the device status of the business device, and a communication route judging section that judges whether a communication route is the intranet or the Internet. An SNMP data processing section extracts, when the communication route is the intranet, OID corresponding to an OID request command from the second information device from the MID information and processes the OID into a form that can be communicated via SNMP. An HTTP data processing section extracts, when the communication route is the Internet, OID corresponding to an OID request command from the first information device from the MIB information, processes the OID into a form that can be communicated via HTTP, and describes the OID as tag information in XML (Extensible Markup Language). The business device further includes a TCP/IP (Transmission Control Protocol/Internet Protocol) that transmits the OID processed by the SNMP data processing section or the HTTP data processing section via a standard protocol used on the Internet.

In addition, the present invention provides an information device that transmits an OID request command to a business device to request transmission of OID indicating individual equipment status in MIB information indicating the device status of the business device. When the information device is connected to the Internet, HTTP is used as a communication protocol for communication between the business device and the information device, and the information device transmits the OID request command to the business device as tag information in XML, so that the business device transmits OID indicating equipment status thereof as XML data to the information device on the basis of the tag information in XML.

In addition, the present invention provides a business device information management system including an information device and a business device. The information device transmits an OID request command to the business device to request transmission of OID indicating individual equipment status in MIB information indicating the device status of the business device. The business device transmits OID corresponding to the OID request command to the information device. When the information device is connected to the Internet, HTTP is used as a communication protocol for communication between the business device and the information device, and the information device transmits the OID request command to the business device as tag information in XML. The business device transmits OID indicating equipment status thereof as XML data to the information device on the basis of the tag information in XML.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a conceptual view showing a communication system of an MFP that is applied to an embodiment of the present invention.

FIG. 2 is a flowchart showing the flow of an operation performed by the communication system of the MFP shown in FIG. 1.

FIG. 3 is a block diagram showing the software configuration of the MFP in the present invention.

FIG. 4 is a block diagram showing the internal structure of an HTTP data processing section in FIG. 3.

### DETAILED DESCRIPTION OF THE PREFERRED EMBODIMENTS

First of all, a business device (i.e. an MFP) in the present invention will be outlined. When communicating with a PC (server) as an information device on an intranet, the MFP in the present invention uses SNMP as a communication protocol as in the past to exchange MIB information indicating the status of the MFP. When communicating with a PC (server) as an information device on the Internet, the MFP uses HTTP (Hyper Text Transfer Protocol) or FTP (File Transfer Protocol), which are protocols generally used on the Internet, to exchange MIB information indicating the status of the MFP. In other words, because a firewall has an HTTP or FTP communication port, the MFP accesses a PC by designating an IP address via a protocol using HTTP or FTP, thereby opening the firewall. In this way, the MFP and a PC on the Internet communicate with each other to exchange MIB information concerning the MFP.

When HTTP or FTP is used as a communication protocol, data described in HTML (Hyper Text Markup Language), XHTML (Extensible Hyper Text Markup Language), XML (Extensible Markup Language), etc. can be handled on the Internet. Among them, XML data is particularly effective for exchange of data between computers. That is, XML allows the user to define data attribute information individually by using his or her own tags and hence enables the document structure to be extremely simple. Accordingly, in the present invention, XML format data is handled when communication is performed via HTTP or FTP between the MFP and a server, e.g. a PC, on the Internet.

More specifically, the MFP of the present invention allows HTTP or FTP to be used as a communication protocol of higher order relative to TCP/IP (Transmission Control Protocol/Internet Protocol), and OID, which is individual equipment information such as counter information, address information, recording paper information or error information in MIB information about the MFP, is described as tag information in XML format. In other words, OID in MIB information which an MFP, e.g. a printer, a scanner, or a FAX, handles on the device is described as tag information in XML format that can be handled on the Internet, thereby allowing data to be easily exchanged between the MFP side that outputs information and the PC side that acquires information.

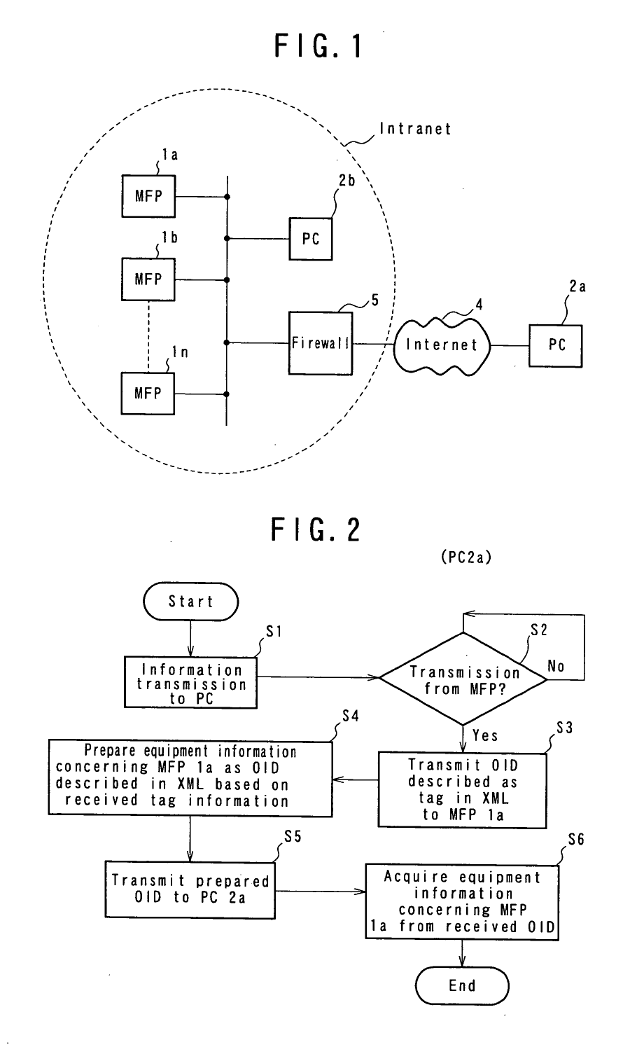

Embodiments of the present invention will be described below in detail with reference to the accompanying drawings. FIG. 1 is a conceptual view showing a communication system of an MFP that is applied to an embodiment of the present invention. FIG. 2 is a flowchart showing the flow of an operation performed by the communication system of the MFP shown in FIG. 1. Accordingly, the flow of the operation performed by the communication system of the MFP in the present invention will be described below with reference to FIGS. 1 and 2. It should be noted that the following description is given to a case where HTTP is used as a protocol that can be handled on the Internet.

As shown in FIG. 1, a large number of MFPs 1a, 1b . . . in are connected to form a network. A PC 2b is communicably connected to the MFPs 1a and 1b via an intranet 3. A PC 2a is communicably connected to the MFPs 1a, 1b . . . in via the Internet 4. A firewall 5 is provided between the PC 2a and the MFPs 1a, 1b . . . in to prevent unauthorized access from the outside. It should be noted that a firewall may be provided for each MFP. In this example, however, one or each firewall is shown representatively by a single firewall 5.

The following is a description of a case where the MFP 1a communicates with the PC 2a or the PC 2b. It should be noted, however, that the same operation takes place when other MFPs perform communication. First, the MFP 1a transmits a command described in XML to the PC 2a by using HTTP as a communication protocol to make an access (information transmission) to the PC 2a (step S1). At this time, the firewall 5 is opened for a predetermined period of time. Upon receipt of the command from the MFP 1a (if “Yes” at step S2), the PC 2a generates, as a response command, OID (e.g. a character string: Get1.3.6.6. . . . ) described as tag information in XML on the basis of an identification number (i.e. the device ID of MFP 1a) included in the command transmitted from the MFP 1a, and transmits the OID to the MFP 1a corresponding to the acquired device ID (step S3). Upon completion of one to-and-fro communication between the MFP 1a and the PC 2a, the firewall 5 is once closed.

Next, the MFP 1a prepares OID in XML on the basis of the tag information in the received OID. That is, the MFP 1a describes in XML equipment information (e.g. counter information) in MIB indicating its own device status that corresponds to the tag information (step S4), and transmits the prepared OID to the PC 2a as equipment information by opening the firewall 5 again through HTTP communication (step S5). Thus, the PC 2a acquires desired equipment information (e.g. counter information) as OID in the MIB indicating the device status of the MFP 1a on the basis of the received OID (step S6). Accordingly, the PC 2a connected to the Internet 4 can acquire equipment information (e.g. counter information) concerning the MFP 1a from the received OID via a communication protocol using HTTP without being blocked by the firewall 5.

It should be noted that the PC 2a can communicate with not only the MFP 1a but also any of the MFPs 1a to In on the basis of device ID received from the desired MFP to acquire desired equipment information as OID from the MFP. Regarding the PC 2b connected on the intranet, the communication protocol is SNMP, and OID may be HTML data. However, OID may also be tag information in XML format.

Regardless of whether communication is performed via the Internet or the intranet, transmission and reception of XML data requires tags that have been agreed upon in advance by both the transmitting side (i.e. MFP side) and the receiving side (i.e. PC side). It is general practice to form tags by using character strings. If tags are defined by character strings, special-purpose software has to be developed in the case of built-in software as used in printers, scanners, FAXs, etc. Therefore, to transmit OID in MIB that is handled on MFP devices, such as printers, scanners and FAXs, as tag information in XML format that can be handled on the Internet, the communicating section needs to prepare tags from OID. However, the information management section may have the same structure as in the past. Therefore, OID can be handled easily. It is also possible for the communicating side to use existing SNMP server software and hence possible to handle OID easily.

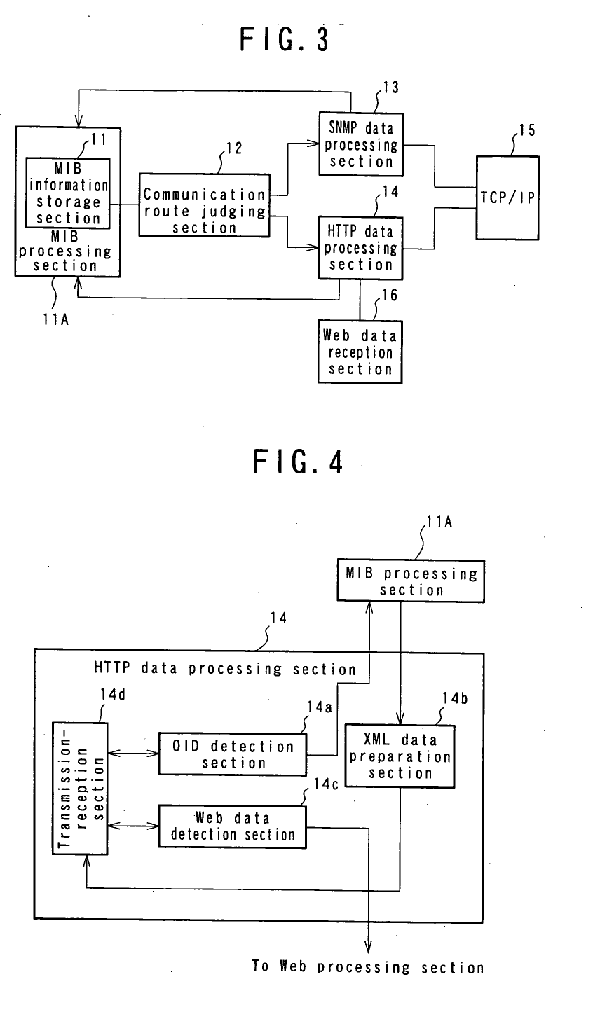

Next, the software configuration of the MFP in the present invention will be described. FIG. 3 is a block diagram showing the software configuration of the MFP in the present invention. FIG. 4 is a block diagram showing the internal structure of an HTTP data processing section in FIG. 3. In the illustration of the software configuration, the way in which the MFP transmits its own MIB information in response to a request from a PC is shown by blocks for each function.

In FIG. 3, the software of the MFP comprises various sections as follows. An MIB processing section 11A has an MIB information storage section 11 into which the MFP stores MIB information indicating its own device status. A communication route judging section 12 judges whether the route of communication with the PC is the intranet or the Internet. An SNMP data processing section 13 extracts, when the route of communication with the PC is the intranet, OID corresponding to the PC's request command from the MIB information and processes the OID into a form that can be communicated via SNMP. An HTTP data processing section 14 extracts, when the route of communication with the PC is the Internet, OID corresponding to the PC's request command from the MIB information and processes the OID into a form that can be communicated via HTTP. Further, the HTTP data processing section 14 describes the OID as tag information in XML. A TCP/IP 15 transmits the OID processed in the SNMP data processing section 13 or the HTTP data processing section 14 via a standard protocol used on the Internet. A Web data reception section 16 receives Web data on the Internet.

In FIG. 4, the HTTP data processing section 14 comprises the following sections. An OID detection section 14a detects, for example, OID communicated via the Internet and sends the detected OID to the MIB processing section 11A. An XML data preparation section 14b converts the OID obtained from the MIB processing section 11A into tag information in XML. A Web data detection section 14c detects Web data communicated via the Internet. A transmission-reception section 14d serves as an interface that exchanges OID or Web data with the Internet.

Next, the operation of the software of the MFP in the present invention will be described with reference to FIGS. 3 and 4. The following is a description of the operation of the software when the MFP transmits, in response to an OID request command from a PC (not shown), the corresponding OID to the PC side. When the MFP receives an OID request command from a PC (not shown), OID corresponding to the OID request command (i.e. any of such equipment information as counter information, address information, recording paper information or error information) is extracted from the MIB information storage section 11. Next, the communication route judging section 12 judges whether the route of communication with the PC that has transmitted the OID request command is the intranet or the Internet. If it is judged that the route of communication with the PC is the intranet, the OID extracted from the MIB information storage section 11 is transmitted to the SNMP data processing section 13.

If the communication route judging section 12 judges that the route of communication with the PC that has transmitted the OID request command is the Internet, the OID extracted from the MIB information storage section 11 is transmitted to the HTTP data processing section 14. In the HTTP data processing section 14, the XML data preparation section 14b converts the OID delivered from the MIB processing section 11A into XML data. Further, the OID converted into XML data is transmitted from the TCP/IP 15 through the transmission-reception section 14d to the requesting PC connected to the Internet.

It should be noted that the foregoing embodiment is merely an example for describing the present invention, and the present invention is not necessarily limited to the described embodiment but can be modified in a variety of ways without departing from the gist of the present invention. Although HTTP is used in the foregoing embodiment as a protocol usable when the MFP and the PC communicate with each other via the Internet, it should be noted that the present invention is not necessarily limited thereto but may be applied to any protocol that can be handled on the Internet. Although XML is used in the foregoing embodiment as a language that is used in HTTP, the present invention is not necessarily limited thereto but may be applied to any simple document structure language usable in a protocol that can be handled on the Internet.

In this embodiment, a program executed by a business device or a PC is usually stored in a ROM. However, the present invention is not necessarily limited thereto. A similar function may be downloaded from a network through an interface. Alternatively, a similar function stored in a storage medium may be installed in the system. Any form of storage medium is usable for the above-described purpose, provided that it is a computer-readable storage medium capable of storing a program, e.g. a flexible disk, a hard disk, an optical disk (CD-ROM, etc.), a magneto-optical disk (MO, etc.), or a semiconductor memory. The present invention is also applicable to a program itself that has been stored in a storage medium as stated above.

As has been described above, the present invention provides a business device, an information device, a business device information management system, a business device information management method, and a business device information management program that are arranged so that a PC on the Internet can easily acquire MIB information concerning a business device, e.g. a printer, a scanner, or a FAX, from the business device.

What is claimed is:

1. A business device capable of transmitting and receiving OID (Order Information Data) indicating individual equipment status in MIB (Management Information Base) information indicating device status of said business device through an Internet to and from an information device connected to said Internet,
wherein when said OID is transmitted and received between said business device and said information device, a communication protocol that can be handled on said Internet is used, and said OID is described as tag information in a language compatible with said communication protocol.

2. A business device according to claim 1, wherein said communication protocol is either one of HTTP (Hyper Text Transfer Protocol) and FTP (File Transfer Protocol), and said language is XML (Extensible Markup Language).

3. A business device according to claim 1, comprising:
an MIB information storage section that stores MIB information indicating device status of said business device;
an HTTP data processing section that extracts OID corresponding to an OID request command from said information device from said MIB information storage section, processes said OID into a form that can be communicated via HTTP, and describes said OID as tag information in XML; and
TCP/IP (Transmission Control Protocol/Internet Protocol) that transmits the OID processed by said HTTP data processing section via a standard protocol used on the Internet.

4. A business device capable of transmitting and receiving OID (Order Information Data) indicating individual equipment status in MIB (Management Information Base) information indicating device status of said business device to and from a first information device connected to an Internet and a second information device connected to an intranet, said business device comprising:
an MIB information storage section that stores MIB information indicating device status of said business device;
a communication route judging section that judges whether a communication route is the intranet or the Internet;
an SNMP (Simple Network Management Protocol) data processing section that extracts, when the communication route is said intranet, OID corresponding to an OID request command from said second information device from said MID information and processes said OID into a form that can be communicated via SNMP;
an HTTP (Hyper Text Transfer Protocol) data processing section that extracts, when the communication route is said Internet, OID corresponding to an OID request command from said first information device from said MIB information, processes said OID into a form that can be communicated via HTTP, and describes said OID as tag information in XML ((Extensible Markup Language); and
a TCP/IP (Transmission Control Protocol/Internet Protocol) that transmits the OID processed by said SNMP data processing section or said HTTP data processing section via a standard protocol used on the Internet.

5. A business device according to claim 4, wherein said HTTP data processing section includes:
an OID detection section that detects said OID communicated via said Internet and sends said OID to an MIB processing section; and
an XML data preparation section that describes the OID obtained from said MIB processing section as tag information in XML.

6. An information device that transmits an OID (Order Information Data) request command to a business device to request transmission of OID indicating individual equipment status in MIB (Management Information Base) information indicating device status of said business device,
wherein when said information device is connected to an Internet, HTTP is used as a communication protocol for communication between said business device and said information device, and
said information device transmits said OID request command to said business device as tag information in XML (Extensible Markup Language),
so that said business device transmits OID indicating equipment status thereof as XML data to said information device on a basis of said tag information in XML.

7. A business device information management system including an information device and a business device, said information device transmitting an OID (Order Information Data) request command to said business device to request transmission of OID indicating individual equipment status in MIB (Management Information Base) information indicating device status of said business device, said business device transmitting OID corresponding to said OID request command to said information device,
wherein when said information device is connected to an Internet, HTTP is used as a communication protocol for communication between said business device and said information device,
said information device transmits said OID request command to said business device as tag information in XML (Extensible Markup Language), and
said business device transmits OID indicating equipment status thereof as XML data to said information device on a basis of said tag information in XML.

8. A business device information management method wherein OID (Order Information Data) indicating individual equipment status in MIB (Management Information Base) information indicating device status of a business device is transmitted to an information device connected to an Internet to perform information management of said business device, said method comprising:
a step in which said business device accesses said information device via a communication protocol using HTTP (Hyper-Text Transfer Protocol);
a step in which said information device transmits an OID request command to said business device as tag information in XML (Extensible Markup Language) in response to the access from said business device;
a step in which said business device describes OID corresponding to said OID request command in XML and transmits said OID to said information device; and
a step in which said information device acquires equipment status of said business device on a basis of the received OID.

9. An information management program for a business device capable of transmitting and receiving OID (Order Information Data) indicating individual equipment status in MIB (Management Information Base) information indicating device status of said business device through an Internet to and from an information device connected to said Internet, said program instructing a computer to execute the steps of:
processing an OID request command from said information device;
extracting OID corresponding to the OID request command from an MIB information storage section and describing said OID as tag information in XML (Extensible Markup Language); and
transmitting the OID described as tag information in XML via a standard protocol used on the Internet.
